(19) United States
(12) Patent Application Publication
(10) Pub. No.: US 2025/0180917 A1
(43) Pub. Date: Jun. 5, 2025

(54) SYSTEMS AND METHODS FOR NEW VR DEVICE FORM-FACTOR

(71) Applicant: Meta Platforms Technologies, LLC, Menlo Park, CA (US)

(72) Inventor: Leonardo Aldana, Tracy, CA (US)

(21) Appl. No.: 18/954,418

(22) Filed: Nov. 20, 2024

Related U.S. Application Data
(60) Provisional application No. 63/605,761, filed on Dec. 4, 2023.

(51) Int. Cl. G02B 27/01; G06F 1/16

(52) U.S. Cl. CPC G02B 27/0176; G06F 1/163; G02B 2027/0152

(57) ABSTRACT

Systems for an improved VR device form-factor may include a head-mounted display; a rear unit that is adjustable to fit a user; and a transition unit housing at least one electronic subsystem, wherein the transition unit extends between the head-mounted display and the rear unit so as to cover a top portion of a user's head when worn by the user; and the transition unit comprises a front unit portion and a rear portion that is rotatable with respect to the front unit portion.

### CROSS-REFERENCE TO RELATED APPLICATIONS

This application claims priority to U.S. Application 63/605,761, filed 4 Dec. 2023, the disclosure of which is incorporated, in its entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is an illustration of exemplary virtual reality head-mounted display according to some embodiments of this disclosure.

FIG. 2 is a perspective view of exemplary virtual reality head-mounted display according to some embodiments of this disclosure.

FIG. 3 is an illustration of exemplary virtual reality head-mounted display worn by a user according to some embodiments of this disclosure.

FIG. 4 is an illustration of exemplary virtual reality head-mounted display according to some embodiments of this disclosure.

FIG. 5 is an illustration of exemplary virtual reality head-mounted display according to some embodiments of this disclosure.

FIG. 6 is an illustration of exemplary virtual reality head-mounted display attached to a charging stand according to some embodiments of this disclosure.

FIG. 7 is a flow diagram of an exemplary method for rotating a virtual reality head-mounted display according to some embodiments of this disclosure.

FIG. 8 is an illustration of an example artificial-reality system according to some embodiments of this disclosure.

FIG. 9 is an illustration of an example artificial-reality system with a handheld device according to some embodiments of this disclosure.

FIG. 10 is an illustration of an example wrist-wearable device of an artificial-reality system according to some embodiments of this disclosure.

FIG. 11 is an illustration of an example wearable artificial-reality system according to some embodiments of this disclosure.

FIG. 12 is an illustration of an example augmented-reality system according to some embodiments of this disclosure.

FIG. 13A is an illustration of an example virtual-reality system according to some embodiments of this disclosure.

FIG. 13B is an illustration of another perspective of the virtual-reality systems shown in FIG. 13A.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Head-mounted displays (HMDs, display device, headset, etc.), particularly those used in virtual reality (VR) applications, typically present challenges in design and usability. The compact and lightweight design needed for VR HMDs demands optimal placement of components for weight distribution. For example, components such as processors, batteries, and display elements are often positioned out of balance on a user's head leading to discomfort, but this is still done to keep the device as simple, low over-all weight and as low-cost as possible. Additionally, such devices may feature complex form factors, such as rear- and front-positioned compute modules, which may require innovative configurations to achieve the demands of VR HMDs. For example, headset configurations that use a rear compute module to address comfort commonly require communication between the rear compute module and displays and sensors located at the front of the headset. The long distance derived from signal wires going around the user's head may necessitate the use of signal amplifiers and intermediate circuit boards to compensate for signal losses caused by such long distances. Moreover, the traditional HMD form factor, with its forward-weighted design, may lead to user discomfort and manufacturing complexities that impact both user experience and bill of materials (BOM) costs.

As such, the present disclosure is generally directed to systems and methods for an improved VR device form-factor. In some embodiments, the improved VR device form-factor may include a central body that may pass over the top of a user's head and mounts without the use of side straps. The VR device may include an adjustable central body that starts from a front unit and may run over the user's head along the center, extending to a back unit. In further embodiments, the front unit and the back unit may include mounting pads to contact and secure the VR device to the user's head. Various electronic components may be distributed along the strap so as to move them along the z-axis, thereby achieving a balanced weight for the user's comfort and wearability. Thus, the weight of the components may be distributed along the headset from the front unit to the back unit.

In other embodiments, the improved VR device form factor may include rear computes configured to communicate with display devices and sensors in the front unit. Various electronic components, such as a main board, may be placed in between a battery and the display devices and sensors. The improved VR device form factor may thus reduce the distance from the battery to the main board and the distance from the sensors to the main board in such a way that signal amplifiers and added wire gauges are not required to provide high-quality signal transmission between the distributed components, thus reducing weight and manufacturing costs of the VR device. Additionally, since the battery, which may be the heaviest part of the device, is located at the back of the user's head, the improved VR device form factor may provide a balanced headset that ends up being lighter and more comfortable to wear than conventional headset devices.

Features from any of the embodiments described herein may be used in combination with one another in accordance with the general principles described herein. These and other embodiments, features, and advantages will be more fully understood upon reading the following detailed description in conjunction with the accompanying drawings and claims.

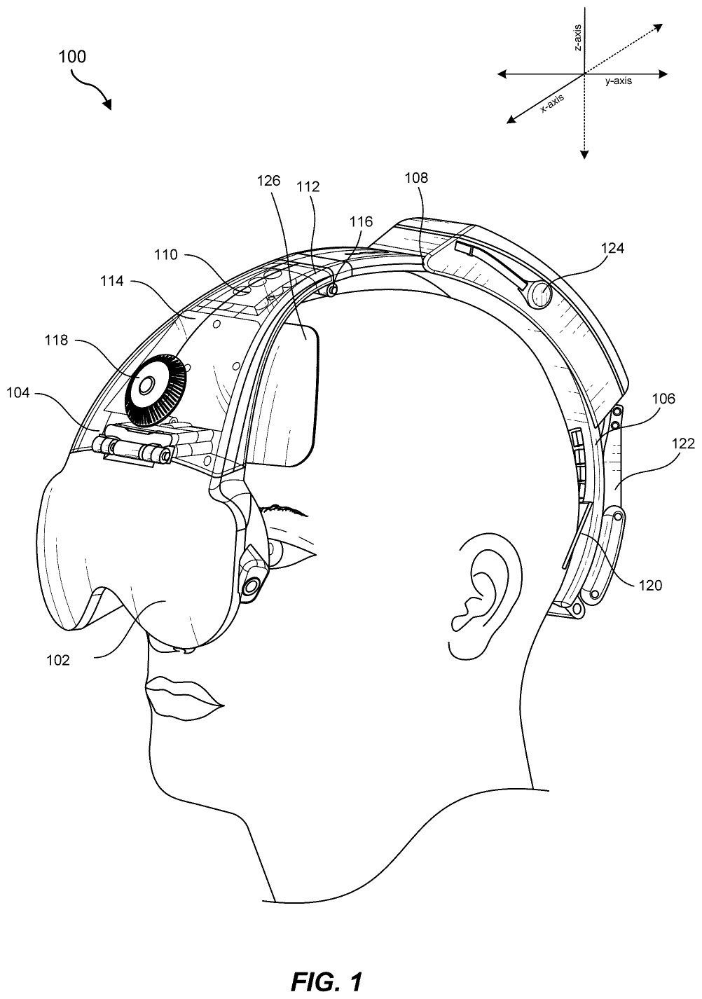

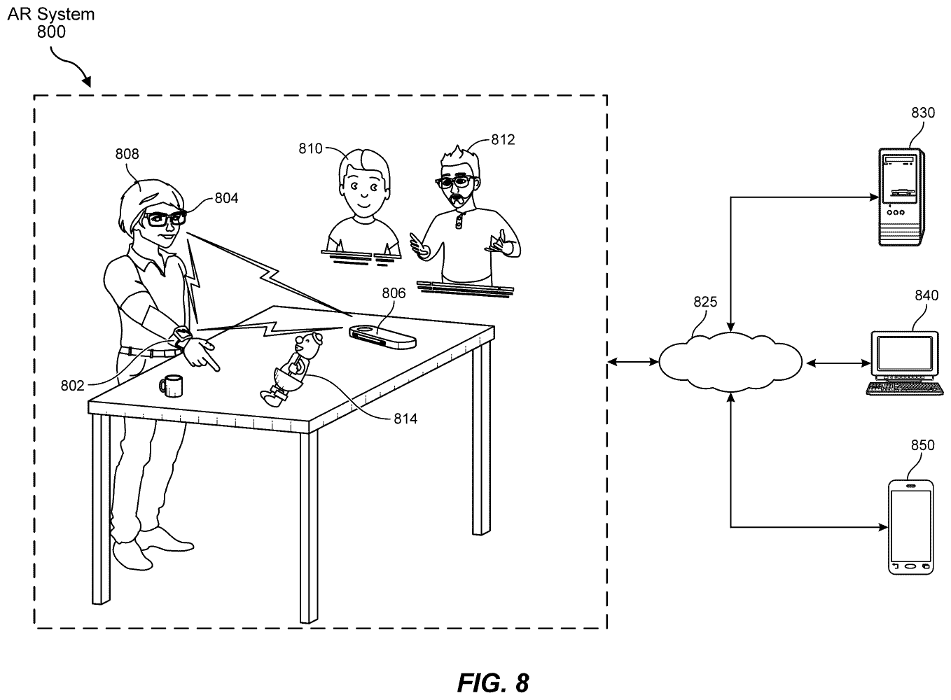

The following will provide, with reference to FIGS. 1-7, detailed descriptions of systems and methods that include a VR device form-factor. The descriptions corresponding to FIGS. 8-13B will provide examples of various systems and devices implementing embodiments presented herein.

FIG. 1 is an illustration of an example VR device 100. The VR device 100 may include a display device 102, a front unit 104, a rear unit 106 that is adjustable to fit a user, and a transition unit 108 that may house at least one electronic subsystem. The term “electronic subsystem,” as used herein, may generally refer to any type or form of component capable of managing, processing, and/or transmitting electronic signals. Electronic subsystems may be formed from a variety of different materials, including without limitation, conductive and non-conductive materials. In some examples, electronic subsystems may include fan(s) 110 (e.g., hot air exhaust), antennae 112, and circuit board 114. In some examples, the VR device 100 may include an open internal volume (e.g., open cavity) that may house additional electronic subsystems, including, but not limited to, batteries, cameras, central processing unit (CPU), display, and/or any other suitable electronic components. The housed and/or supported electronic subsystems may be variably positioned along a z-axis and/or a y-axis of the transition unit 108 to further enhance the weight distribution of the VR device 100. In further examples, the transition unit 108 may extend between the front unit 104 and the rear unit 106 to cover a top position of the user's head when worn by the user.

In some examples, the VR device 100 may include a hinge joint 116 (e.g., friction type hinge joint, compound hinge joint, etc.) that may enable dynamic rotation the VR device 100. Additionally, the VR device 100 may include a feature to enable the display device 102 to slide in and out with respect to other portions of the VR device 100. The sliding of the display device 102 may be controllable via, for example, a dial 118 positioned on a surface of the VR device 100. In some examples, the rear unit 106 may be variably adjusted to fit the user by adjusting mechanisms such as a rear pad 120 and fit adjustment mechanism 122. In some examples, variably adjusting the rear unit 106 may further enhance the comfort for the user. In other examples, the rear unit 106 may be configured to house electronic subsystems and support audio subsystems capable of projecting sound to the user. For example, the audio subsystems may project sound to the user via transmission of vibrations through the rear pad 120 and/or via retractable earphones 124.

In some examples, the VR device 100 may be secured to the user's head at a front pad 126 and the rear pad 120 so that portions of the VR device 100 do not contact portions of the user's head between the user's forehead and rear of the user's head (i.e., the user's occipital lobe). Conventional headsets having over-the-head straps, on the other hand, may contact the top of a user's head and can undesirably mess up the user's hair, cause discomfort to the user, etc.

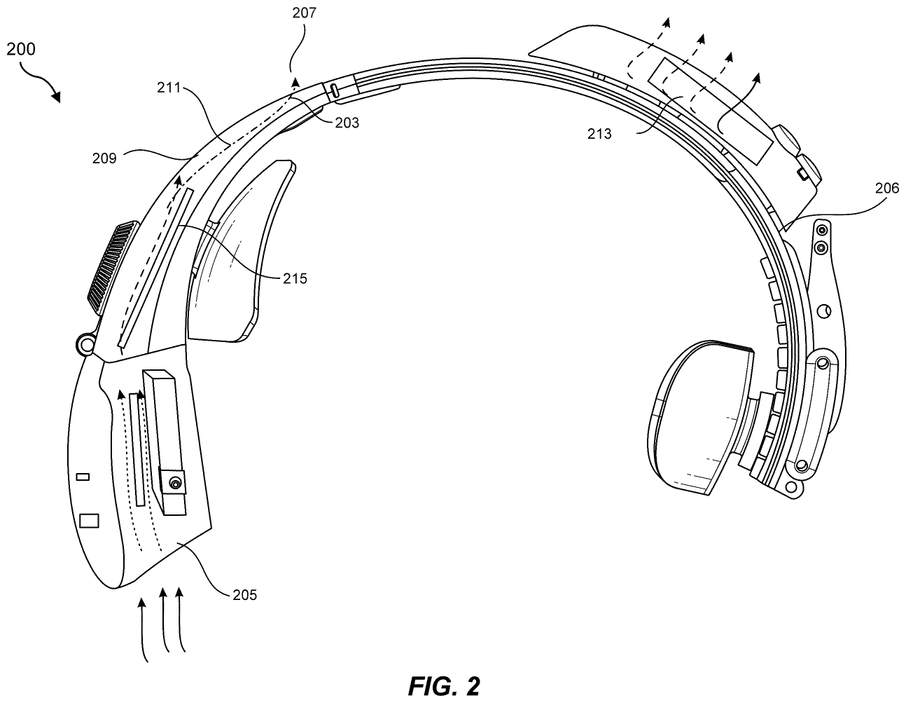

FIG. 2 is an illustration of a perspective view of an example VR device 200. The VR device 200 may further include a heat management system designed to dissipate heat within the VR device 200 expelled from the electronic subsystems, such as battery 213 and main board 215. The term “heat management system” as used herein, may generally refer to any type and/or form of element capable of facilitating the process of moving away from a source and into the surrounding environment. Types of elements in the heat management system may include fan(s) 203, an intake region 205, an output region 207 (e.g. an exhaust region positioned above the user's head), and an external surface 209 that may include and/or represent a relatively wide surface area in contrast to convention headstraps. The relatively wide surface area of the external surface 209 may contribute to reducing the number of internal layers within the VR device 200. For example, the relatively wide surface area of the external surface 209 may provide space for electronics subsystems that would otherwise need to be located within internal layers of VR device 200. Additionally or alternatively the relatively wide surface area of the external surface 209 may provide additional exposed surface area for heat conduction. In further examples, the external surface 209 may include a metallic material, metallic alloy, and/or any other type or form of heat conductive material. Designing the external surface 209 in this way may facilitate heat dissipation throughout the VR device 200 and corresponding electronic subsystems. The design structure of VR device 200 may include a single airflow system 211 where the fan(s) channel air from the intake region 205 and direct cool air into VR device 200. In some examples, the heat management system may be designed to actively and/or passively cool the electronic subsystems within the VR device 200. For example, a rear unit 206 may include an exhaust fan to actively cool the electronic subsystems housed in the rear unit.

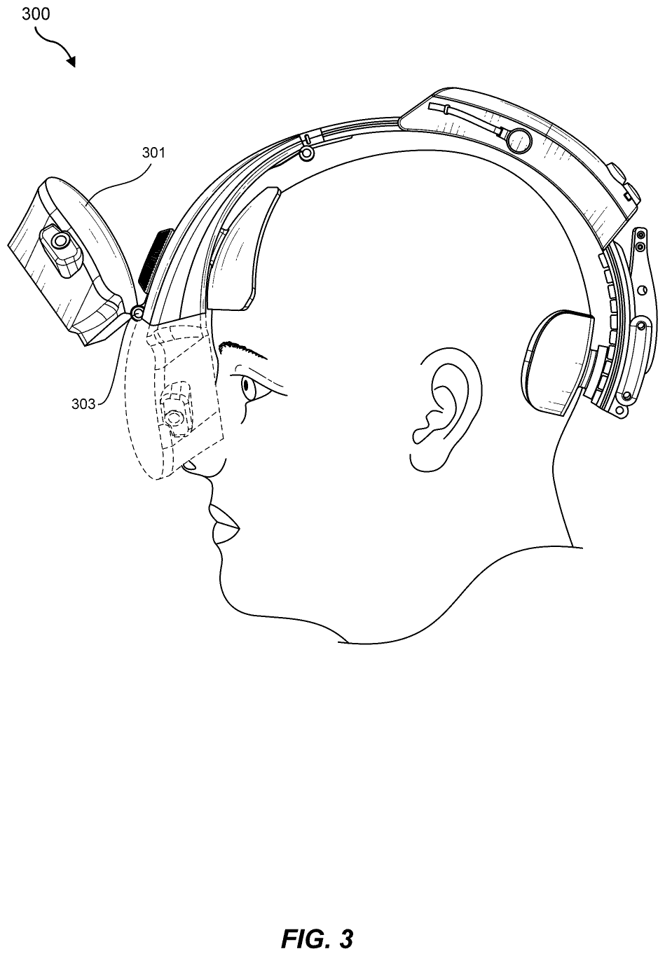

FIG. 3 is an illustration of a perspective view of an example VR device 300. In some examples, the VR device 300 may be configured to selectively lift a display device 301 using a hinge joint 303. Lifting the display device 301 in this way may enable a user to actively switch back and forth from a view of the VR display to an unimpeded real world view without removing the VR device 300 from their head. In some examples, lifting the display device 301 may prompt a privacy setting designed to shut off cameras within display device 301. In further examples, lifting display device 301 may prompt a battery saving setting by sending VR device 300 into a standby mode.

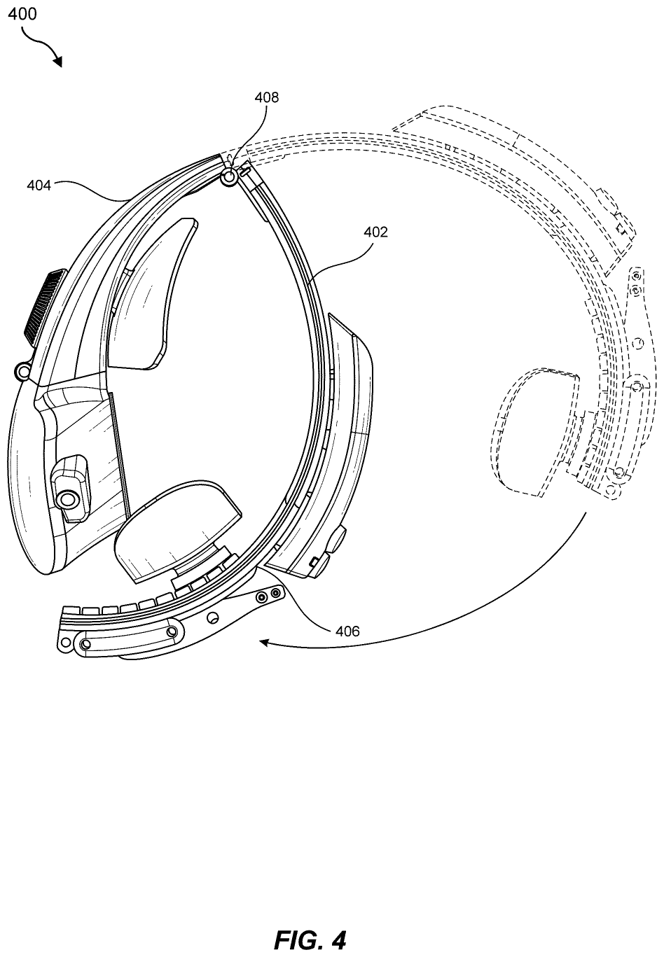

FIG. 4 is an illustration of an example VR device 400 that is rotated via a hinge joint 408. The VR device 400 may include a transition unit 402, a front unit 404, and a rear unit 406. In some examples, the transition unit 402 is rotatable with respect to the front unit 404 via the hinge joint 408. The rotation of the transition unit 402 and/or the rear unit 406 with respect to the front unit 404 may decrease a volume occupied by the VR device 400 via bending, folding, collapsing, etc. The VR device 400 may include a modular form factor capable of improving the comfort and immersiveness of a VR experience of the user compared to traditional headset configurations.

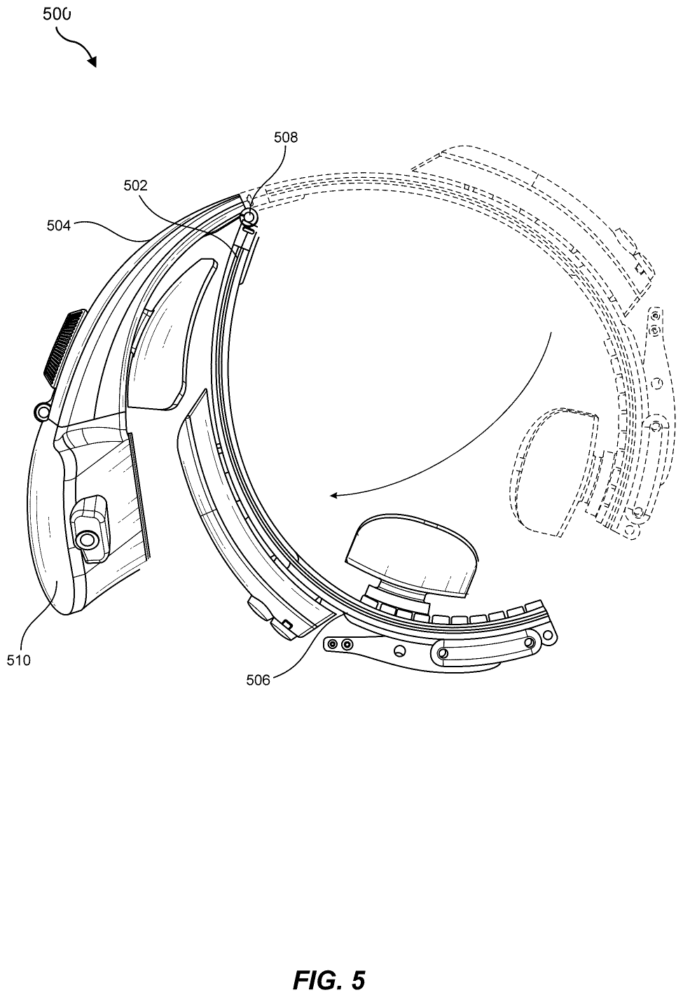

FIG. 5 is an illustration of an example VR device 500 that is rotated in an alternate position. VR device 500 may include a transition unit 502, a front unit 504, and a rear unit 506. In some examples, the rear unit 506 may further include a hinge joint 508 that enables the rear unit 506 to rotate dynamically with respect to the display device 510. In further examples, the hinge joint 508 may be configured to enable the front unit 504 and the rear unit 506 to nest into each other when folded. For example, the hinge joint 508 may enable rotation of the rear unit 506 about multiple axes relative to the front unit 504. Additionally or alternatively, multiple hinge joints be coupled between the front unit 504 and the rear unit 506 provide multiple axes of rotation between the front unit 504 and the rear unit 506.

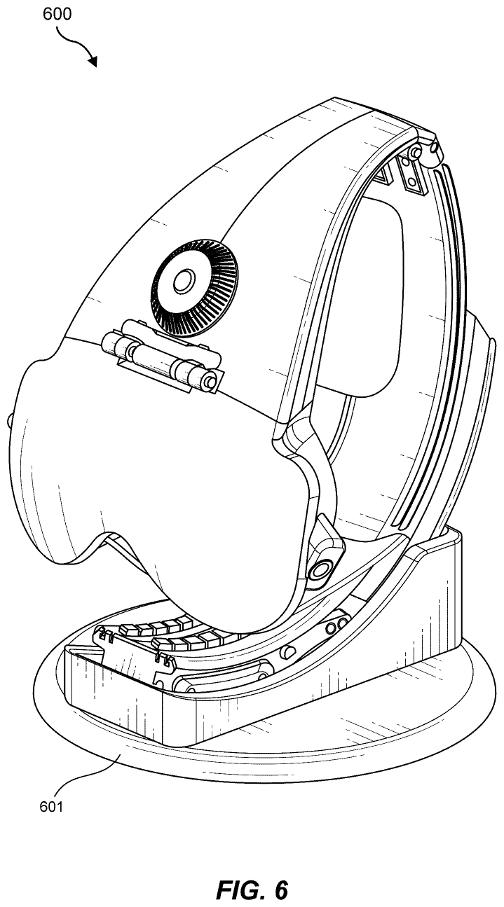

FIG. 6 is an illustration of an example VR device 600 attached to a charging stand 601. The charging stand 601 may be configured to charge the VR device 600 by directing power to the VR device 600. As illustrated, the charging stand 601 may be dimensioned to receive and support the VR device 600. In some embodiments, the VR device 600 may be positioned on the charging stand 601 in a folded configuration as illustrated.

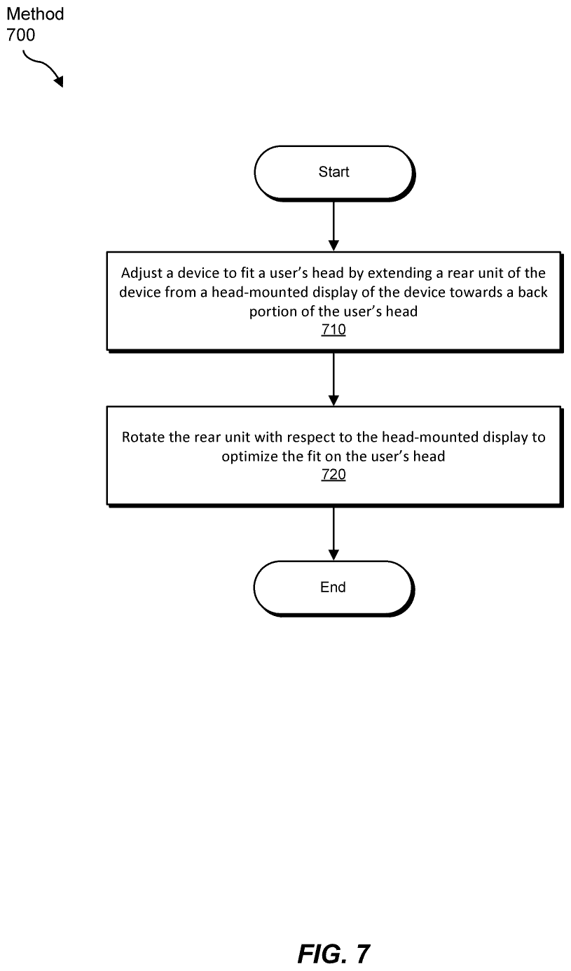

FIG. 7 is a flow diagram of an exemplary method 700 for adjusting a VR device to be worn on a user's head, according to some examples. Step 710 may include adjusting a device to fit a user's head by extending a rear unit of the device from a head-mounted display of the device towards a back portion of the user's head. For example, as illustrated in FIG. 1, the VR device 100 may be adjusted to fit a user's head by extending the rear unit 106 from the display device 102 towards the back portion of the user's head. In some examples, adjusting the rear unit may include sliding the rear unit relative to the head-mounted display to variably adjust the fit for different users. For example, as illustrated in FIG. 1, the rear unit 106 may be slid relative to the display device 102 to variably adjust the fit for different users.

Step 720 may include rotating the rear unit with respect to the head-mounted display to optimize the fit on the user's head. For example, as illustrated in FIG. 1, the rear unit 106 may be rotated with respect to the display device 102 to optimize the fit on the user's head. In some examples, rotating the rear unit with respect to the head-mounted display may include using a compound hinge joint to enable the rotation. For example, as illustrated in FIG. 1, the rear unit 106 may be rotated with respect to the front unit 104 by using the hinge joint 116. The method for rotating the VR device may further include rotating a transition unit of the device that extends between the head-mounted display and the rear unit such that a rear portion of the transition unit rotates with respect to a front portion of the transition unit to collapse the device into a more compact form. For example, as illustrated in FIG. 1, the transition unit 108 of VR device 100 that extends between the display device 102 and the rear unit 106 may be rotated such that the rear unit 106 rotates with respect to the front unit 104 to collapse the VR device 100 in a more compact form.

### EXAMPLE EMBODIMENTS

Example 1: A device including 1) a head-mounted display, 2) a rear unit that is adjustable to fit a user, and 3) a transition unit housing at least one electronic subsystem, where the transition unit extends between the head-mounted display and the rear unit so as to cover top portion of a user's head when worn by the user and the transition unit includes a front unit portion and a rear portion that is rotatable with respect to the front unit portion

Example 2: The device of example 1, where the head-mounted display further include a thermal management system configured to cool the electronic subsystems passively.

Example 3: The device of example 1, where the head-mounted display includes a friction-type hinge joint enabling dynamic rotation of the head-mounted display relative to the transition unit.

Example 4: The device of example 1, where the rear unit includes a fit adjustment mechanism that allows the rear unit to be variably adjusted.

Example 5: The device of example 1, where the rear unit includes an audio subsystem configured to project sound to the user through a rear pad.

Example 6: The device of example 1, where the transition unit includes a compound hinge configured to enable the rear portion and front portion to nest into each other when folded.

Example 7: The device of example 1, where the transition unit further includes a sliding front module that is operable via a dial positioned on a surface of the head-mounted display, allowing the sliding front module to slide in and out relative to the head-mounted display.

Example 8: The device of example 1, where the transition unit further includes an airflow system including an intake region configured to direct cool air into the device.

Example 9: The device of example 8, where the airflow system further includes an exhaust region positioned above the user's head to expel hot air.

Example 10: The device of example 1, wherein the transition unit houses an antenna positioned along a z-axis of the transition unit.

Example 11: A device including 1) a head-mounted display, and 2) a rear unit that is adjustable and linked to the head-mounted display to fit a user, the rear unit housing at least one electronic subsystem, where the rear unit extends from the head-mounted display towards a back side of the user so as to cover a top portion of a user's head when worn by the user and the rear unit includes a body that is be rotatable with respect to the head-mounted display.

Example 12: The device of example 11, where the rear unit further includes an audio subsystem configured to transmit sound to the user through vibrations transmitted by a rear pad.

Example 13: The device of example 11, where the rear unit further includes an exhaust fan for actively cooling the electronic subsystems housed in the rear unit.

Example 14: The device of example 11, where the rear unit further includes a compound hinge joint that allows the rear unit to rotate dynamically with respect to the head-mounted display.

Example 15: The device of example 11, where the rear unit includes a fit adjustment mechanism that allows the rear unit to be variably adjusted to fit the user.

Example 16: The device of example 11, where the rear unit includes electronic subsystems variably positioned along a y-axis and/or a z-axis of the rear unit to balance the device when worn by the user.

Example 17: A method for a rotatable device including 1) adjusting a device to fit a user's head by extending a rear unit of the device from a head-mounted display of the device towards a back portion of the user's head and 2) rotating the rear unit with respect to the head-mounted display to optimize the fit on the user's head.

Example 18: The method of example 17, further including rotating a transition unit of the device that extends between the head-mounted display and the rear unit such that a rear portion of the transition unit rotates with respect to a front portion of the transition unit to collapse the device into a more compact form.

Example 19: The method of example 17, where the step of rotating the rear portion of the transition unit with respect to the front portion includes using a compound hinge joint to enable the rotation.

Example 20: The method of example 17, where the step of adjusting the rear unit includes sliding the rear unit relative to the head-mounted display to variably adjust the fit for different users.

Embodiments of the present disclosure may include or be implemented in conjunction with various types of Artificial-Reality (AR) systems. AR may be any superimposed functionality and/or sensory-detectable content presented by an artificial-reality system within a user's physical surroundings. In other words, AR is a form of reality that has been adjusted in some manner before presentation to a user. AR can include and/or represent virtual reality (VR), augmented reality, mixed AR (MAR), or some combination and/or variation of these types of realities. Similarly, AR environments may include VR environments (including non-immersive, semi-immersive, and fully immersive VR environments), augmented-reality environments (including marker-based augmented-reality environments, markerless augmented-reality environments, location-based augmented-reality environments, and projection-based augmented-reality environments), hybrid-reality environments, and/or any other type or form of mixed- or alternative-reality environments.

AR content may include completely computer-generated content or computer-generated content combined with captured (e.g., real-world) content. Such AR content may include video, audio, haptic feedback, or some combination thereof, any of which may be presented in a single channel or in multiple channels (such as stereo video that produces a three-dimensional (3D) effect to the viewer). Additionally, in some embodiments, AR may also be associated with applications, products, accessories, services, or some combination thereof, that are used to, for example, create content in an artificial reality and/or are otherwise used in (e.g., to perform activities in) an artificial reality.

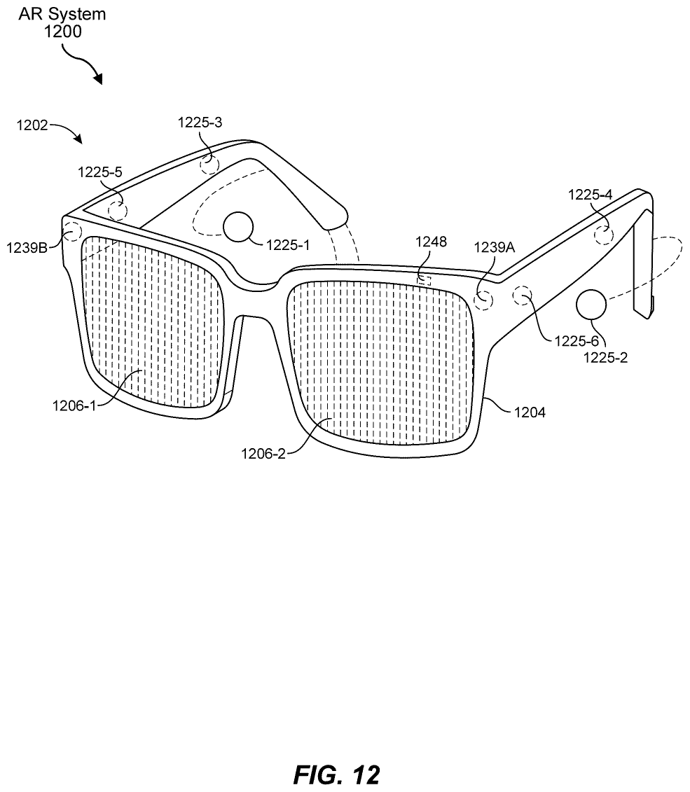

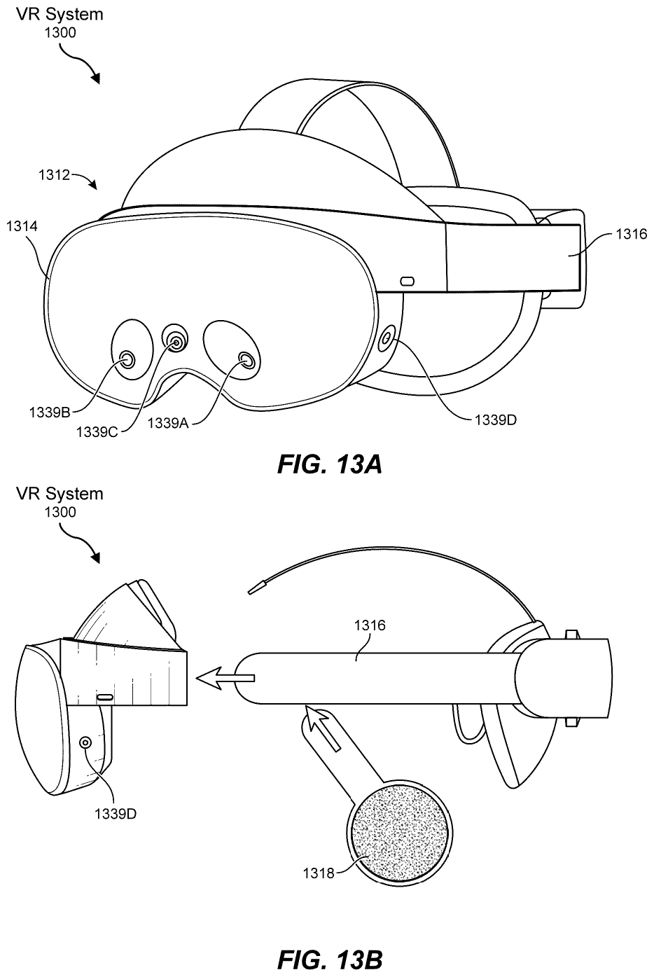

AR systems may be implemented in a variety of different form factors and configurations. Some AR systems may be designed to work without near-eye displays (NEDs). Other AR systems may include a NED that also provides visibility into the real world (such as, e.g., augmented-reality system 1200 in FIG. 12) or that visually immerses a user in an artificial reality (such as, e.g., virtual-reality system 1300 in FIGS. 13A and 13B). While some AR devices may be self-contained systems, other AR devices may communicate and/or coordinate with external devices to provide an AR experience to a user. Examples of such external devices include handheld controllers, mobile devices, desktop computers, devices worn by a user, devices worn by one or more other users, and/or any other suitable external system.

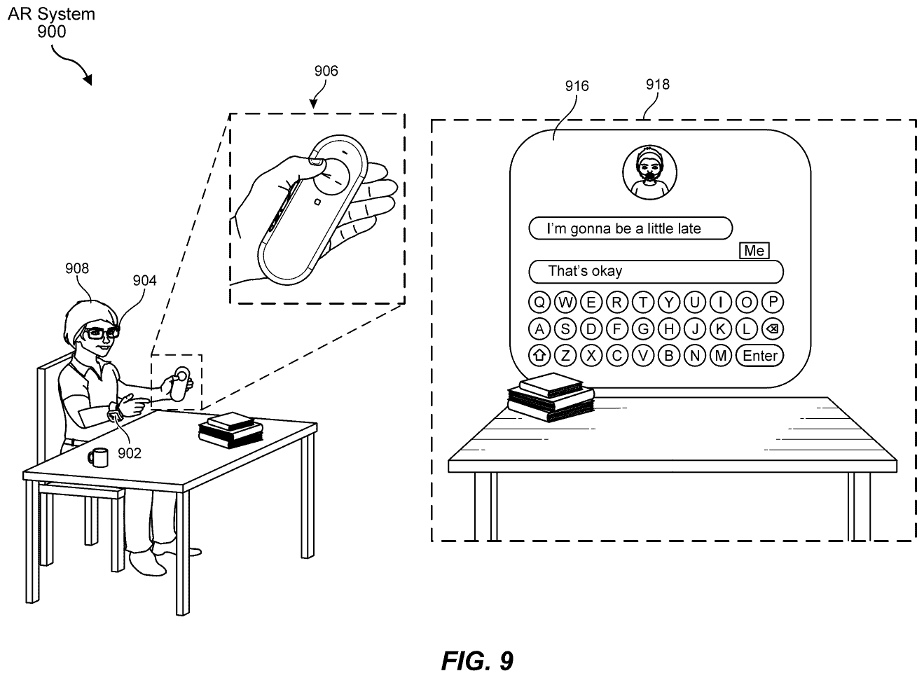

FIGS. 8-9 illustrate example artificial-reality (AR) systems in accordance with some embodiments. FIG. 8 shows a first AR system 800 and first example user interactions using a wrist-wearable device 802, a head-wearable device (e.g., AR glasses 1200), and/or a handheld intermediary processing device (HIPD) 806. FIG. 9 shows a second AR system 900 and second example user interactions using a wrist-wearable device 902, AR glasses 904, and/or an HIPD 906.

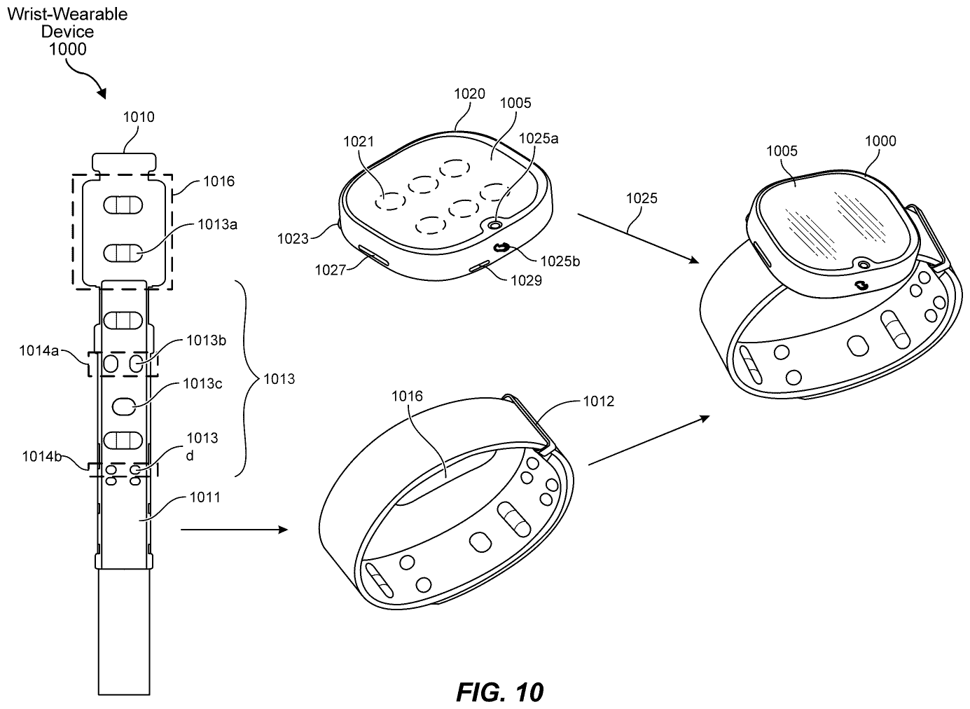

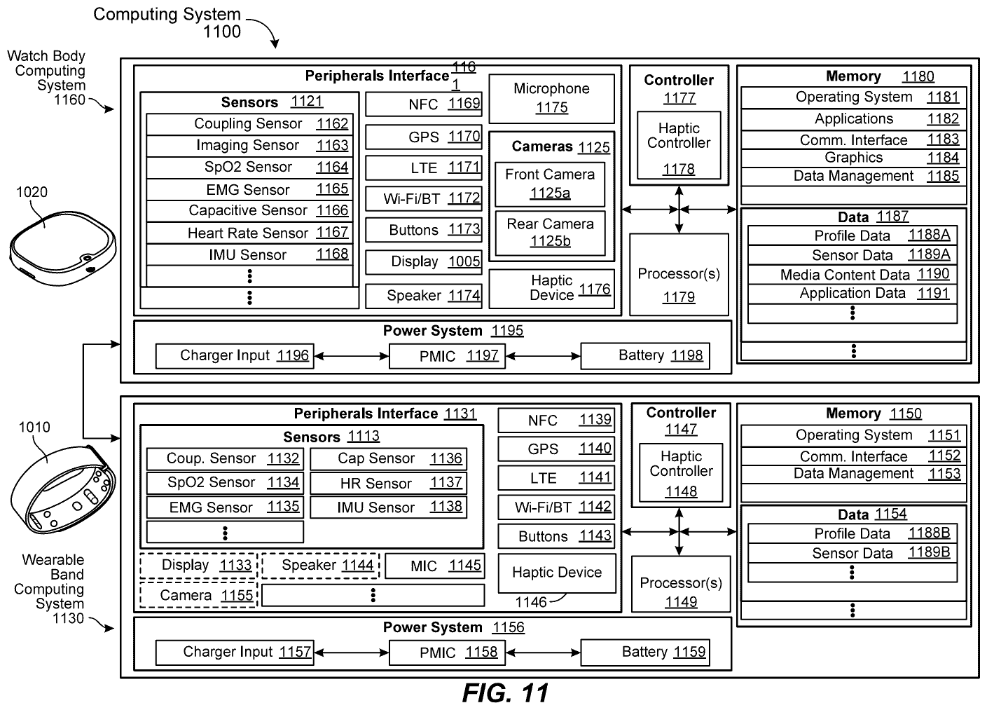

A wrist-wearable device 1000, which can be used for wrist-wearable device 802, 902, and one or more of its components, are described below in reference to FIGS. 10 and 11; head-wearable devices 1200 and 1300, which can respectively be used for AR glasses 804, 904 and their one or more components are described below in reference to FIGS. 12-13.

Referring to FIG. 8, wrist-wearable device 802, AR glasses 804, and/or HIPD 806 can communicatively couple via a network 825 (e.g., cellular, near field, Wi-Fi, personal area network, wireless LAN, etc.). Additionally, wrist-wearable device 802, AR glasses 804, and/or HIPD 806 can also communicatively couple with one or more servers 830, computers 840 (e.g., laptops, computers, etc.), mobile devices 850 (e.g., smartphones, tablets, etc.), and/or other electronic devices via network 825 (e.g., cellular, near field, Wi-Fi, personal area network, wireless LAN, etc.).

In FIG. 8, a user 808 is shown wearing wrist-wearable device 802 and AR glasses 804 and having HIPD 806 on their desk. The wrist-wearable device 802, AR glasses 804, and HIPD 806 facilitate user interaction with an AR environment. In particular, as shown by first AR system 800, wrist-wearable device 802, AR glasses 804, and/or HIPD 806 cause presentation of one or more avatars 810, digital representations of contacts 812, and virtual objects 814. As discussed below, user 808 can interact with one or more avatars 810, digital representations of contacts 812, and virtual objects 814 via wrist-wearable device 802, AR glasses 804, and/or HIPD 806.

User 808 can use any of wrist-wearable device 802, AR glasses 804, and/or HIPD 806 to provide user inputs. For example, user 808 can perform one or more hand gestures that are detected by wrist-wearable device 802 (e.g., using one or more EMG sensors and/or IMUs, described below in reference to FIGS. 10 and 11) and/or AR glasses 804 (e.g., using one or more image sensor or camera, described below in reference to FIGS. 12-13) to provide a user input. Alternatively, or additionally, user 808 can provide a user input via one or more touch surfaces of wrist-wearable device 802, AR glasses 804, HIPD 806, and/or voice commands captured by a microphone of wrist-wearable device 802, AR glasses 804, and/or HIPD 806. In some embodiments, wrist-wearable device 802, AR glasses 804, and/or HIPD 806 include a digital assistant to help user 808 in providing a user input (e.g., completing a sequence of operations, suggesting different operations or commands, providing reminders, confirming a command, etc.). In some embodiments, user 808 can provide a user input via one or more facial gestures and/or facial expressions. For example, cameras of wrist-wearable device 802, AR glasses 804, and/or HIPD 806 can track eyes of user 808 for navigating a user interface.

Wrist-wearable device 802, AR glasses 804, and/or HIPD 806 can operate alone or in conjunction to allow user 808 to interact with the AR environment. In some embodiments, HIPD 806 is configured to operate as a central hub or control center for the wrist-wearable device 802, AR glasses 804, and/or another communicatively coupled device. For example, user 808 can provide an input to interact with the AR environment at any of wrist-wearable device 802, AR glasses 804, and/or HIPD 806, and HIPD 806 can identify one or more back-end and front-end tasks to cause the performance of the requested interaction and distribute instructions to cause the performance of the one or more back-end and front-end tasks at wrist-wearable device 802, AR glasses 804, and/or HIPD 806. In some embodiments, a back-end task is a background processing task that is not perceptible by the user (e.g., rendering content, decompression, compression, etc.), and a front-end task is a user-facing task that is perceptible to the user (e.g., presenting information to the user, providing feedback to the user, etc.). HIPD 806 can perform the back-end tasks and provide wrist-wearable device 802 and/or AR glasses 804 operational data corresponding to the performed back-end tasks such that wrist-wearable device 802 and/or AR glasses 804 can perform the front-end tasks. In this way, HIPD 806, which has more computational resources and greater thermal headroom than wrist-wearable device 802 and/or AR glasses 804, performs computationally intensive tasks and reduces the computer resource utilization and/or power usage of wrist-wearable device 802 and/or AR glasses 804.

In the example shown by first AR system 800, HIPD 806 identifies one or more back-end tasks and front-end tasks associated with a user request to initiate an AR video call with one or more other users (represented by avatar 810 and the digital representation of contact 812) and distributes instructions to cause the performance of the one or more back-end tasks and front-end tasks. In particular, HIPD 806 performs back-end tasks for processing and/or rendering image data (and other data) associated with the AR video call and provides operational data associated with the performed back-end tasks to AR glasses 804 such that the AR glasses 804 perform front-end tasks for presenting the AR video call (e.g., presenting avatar 810 and digital representation of contact 812).

In some embodiments, HIPD 806 can operate as a focal or anchor point for causing the presentation of information. This allows user 808 to be generally aware of where information is presented. For example, as shown in first AR system 800, avatar 810 and the digital representation of contact 812 are presented above HIPD 806. In particular, HIPD 806 and AR glasses 804 operate in conjunction to determine a location for presenting avatar 810 and the digital representation of contact 812. In some embodiments, information can be presented a predetermined distance from HIPD 806 (e.g., within 5 meters). For example, as shown in first AR system 800, virtual object 814 is presented on the desk some distance from HIPD 806. Similar to the above example, HIPD 806 and AR glasses 804 can operate in conjunction to determine a location for presenting virtual object 814. Alternatively, in some embodiments, presentation of information is not bound by HIPD 806. More specifically, avatar 810, digital representation of contact 812, and virtual object 814 do not have to be presented within a predetermined distance of HIPD 806.

User inputs provided at wrist-wearable device 802, AR glasses 804, and/or HIPD 806 are coordinated such that the user can use any device to initiate, continue, and/or complete an operation. For example, user 808 can provide a user input to AR glasses 804 to cause AR glasses 804 to present virtual object 814 and, while virtual object 814 is presented by AR glasses 804, user 808 can provide one or more hand gestures via wrist-wearable device 802 to interact and/or manipulate virtual object 814.

FIG. 9 shows a user 908 wearing a wrist-wearable device 902 and AR glasses 904, and holding an HIPD 906. In second AR system 900, the wrist-wearable device 902, AR glasses 904, and/or HIPD 906 are used to receive and/or provide one or more messages to a contact of user 908. In particular, wrist-wearable device 902, AR glasses 904, and/or HIPD 906 detect and coordinate one or more user inputs to initiate a messaging application and prepare a response to a received message via the messaging application.

In some embodiments, user 908 initiates, via a user input, an application on wrist-wearable device 902, AR glasses 904, and/or HIPD 906 that causes the application to initiate on at least one device. For example, in second AR system 900, user 908 performs a hand gesture associated with a command for initiating a messaging application (represented by messaging user interface 916), wrist-wearable device 902 detects the hand gesture and, based on a determination that user 908 is wearing AR glasses 904, causes AR glasses 904 to present a messaging user interface 916 of the messaging application. AR glasses 904 can present messaging user interface 916 to user 908 via its display (e.g., as shown by a field of view 918 of user 908). In some embodiments, the application is initiated and executed on the device (e.g., wrist-wearable device 902, AR glasses 904, and/or HIPD 906) that detects the user input to initiate the application, and the device provides another device operational data to cause the presentation of the messaging application. For example, wrist-wearable device 902 can detect the user input to initiate a messaging application, initiate and run the messaging application, and provide operational data to AR glasses 904 and/or HIPD 906 to cause presentation of the messaging application. Alternatively, the application can be initiated and executed at a device other than the device that detected the user input. For example, wrist-wearable device 902 can detect the hand gesture associated with initiating the messaging application and cause HIPD 906 to run the messaging application and coordinate the presentation of the messaging application.

Further, user 908 can provide a user input provided at wrist-wearable device 902, AR glasses 904, and/or HIPD 906 to continue and/or complete an operation initiated at another device. For example, after initiating the messaging application via wrist-wearable device 902 and while AR glasses 904 present messaging user interface 916, user 908 can provide an input at HIPD 906 to prepare a response (e.g., shown by the swipe gesture performed on HIPD 906). Gestures performed by user 908 on HIPD 906 can be provided and/or displayed on another device. For example, a swipe gestured performed on HIPD 906 is displayed on a virtual keyboard of messaging user interface 916 displayed by AR glasses 904.

In some embodiments, wrist-wearable device 902, AR glasses 904, HIPD 906, and/or any other communicatively coupled device can present one or more notifications to user 908. The notification can be an indication of a new message, an incoming call, an application update, a status update, etc. User 908 can select the notification via wrist-wearable device 902, AR glasses 904, and/or HIPD 906 and can cause presentation of an application or operation associated with the notification on at least one device. For example, user 908 can receive a notification that a message was received at wrist-wearable device 902, AR glasses 904, HIPD 906, and/or any other communicatively coupled device and can then provide a user input at wrist-wearable device 902, AR glasses 904, and/or HIPD 906 to review the notification, and the device detecting the user input can cause an application associated with the notification to be initiated and/or presented at wrist-wearable device 902, AR glasses 904, and/or HIPD 906.

While the above example describes coordinated inputs used to interact with a messaging application, user inputs can be coordinated to interact with any number of applications including, but not limited to, gaming applications, social media applications, camera applications, web-based applications, financial applications, etc. For example, AR glasses 904 can present to user 908 game application data, and HIPD 906 can be used as a controller to provide inputs to the game. Similarly, user 908 can use wrist-wearable device 902 to initiate a camera of AR glasses 904, and user 308 can use wrist-wearable device 902, AR glasses 904, and/or HIPD 906 to manipulate the image capture (e.g., zoom in or out, apply filters, etc.) and capture image data.

Having discussed example AR systems, devices for interacting with such AR systems and other computing systems more generally will now be discussed in greater detail. Some explanations of devices and components that can be included in some or all of the example devices discussed below are explained herein for ease of reference. Certain types of the components described below may be more suitable for a particular set of devices, and less suitable for a different set of devices. But subsequent reference to the components explained here should be considered to be encompassed by the descriptions provided.

In some embodiments discussed below, example devices and systems, including electronic devices and systems, will be addressed. Such example devices and systems are not intended to be limiting, and one of skill in the art will understand that alternative devices and systems to the example devices and systems described herein may be used to perform the operations and construct the systems and devices that are described herein.

An electronic device may be a device that uses electrical energy to perform a specific function. An electronic device can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device may be a device that sits between two other electronic devices and/or a subset of components of one or more electronic devices and facilitates communication, data processing, and/or data transfer between the respective electronic devices and/or electronic components.

An integrated circuit may be an electronic device made up of multiple interconnected electronic components such as transistors, resistors, and capacitors. These components may be etched onto a small piece of semiconductor material, such as silicon. Integrated circuits may include analog integrated circuits, digital integrated circuits, mixed signal integrated circuits, and/or any other suitable type or form of integrated circuit. Examples of integrated circuits include application-specific integrated circuits (ASICs), processing units, central processing units (CPUs), co-processors, and accelerators.

Analog integrated circuits, such as sensors, power management circuits, and operational amplifiers, may process continuous signals and perform analog functions such as amplification, active filtering, demodulation, and mixing. Examples of analog integrated circuits include linear integrated circuits and radio frequency circuits.

Digital integrated circuits, which may be referred to as logic integrated circuits, may include microprocessors, microcontrollers, memory chips, interfaces, power management circuits, programmable devices, and/or any other suitable type or form of integrated circuit. In some embodiments, examples of integrated circuits include central processing units (CPUs),

Processing units, such as CPUs, may be electronic components that are responsible for executing instructions and controlling the operation of an electronic device (e.g., a computer). There are various types of processors that may be used interchangeably, or may be specifically required, by embodiments described herein. For example, a processor may be: (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) an accelerator, such as a graphics processing unit (GPU), designed to accelerate the creation and rendering of images, videos, and animations (e.g., virtual-reality animations, such as three-dimensional modeling); (iv) a field-programmable gate array (FPGA) that can be programmed and reconfigured after manufacturing and/or can be customized to perform specific tasks, such as signal processing, cryptography, and machine learning; and/or (v) a digital signal processor (DSP) designed to perform mathematical operations on signals such as audio, video, and radio waves. One or more processors of one or more electronic devices may be used in various embodiments described herein.

Memory generally refers to electronic components in a computer or electronic device that store data and instructions for the processor to access and manipulate. Examples of memory can include: (i) random access memory (RAM) configured to store data and instructions temporarily; (ii) read-only memory (ROM) configured to store data and instructions permanently (e.g., one or more portions of system firmware, and/or boot loaders) and/or semi-permanently; (iii) flash memory, which can be configured to store data in electronic devices (e.g., USB drives, memory cards, and/or solid-state drives (SSDs)); and/or (iv) cache memory configured to temporarily store frequently accessed data and instructions. Memory, as described herein, can store structured data (e.g., SQL databases, MongoDB databases, GraphQL data, JSON data, etc.). Other examples of data stored in memory can include (i) profile data, including user account data, user settings, and/or other user data stored by the user, (ii) sensor data detected and/or otherwise obtained by one or more sensors, (iii) media content data including stored image data, audio data, documents, and the like, (iv) application data, which can include data collected and/or otherwise obtained and stored during use of an application, and/or any other types of data described herein.

Controllers may be electronic components that manage and coordinate the operation of other components within an electronic device (e.g., controlling inputs, processing data, and/or generating outputs). Examples of controllers can include: (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs.

A power system of an electronic device may be configured to convert incoming electrical power into a form that can be used to operate the device. A power system can include various components, such as (i) a power source, which can be an alternating current (AC) adapter or a direct current (DC) adapter power supply, (ii) a charger input, which can be configured to use a wired and/or wireless connection (which may be part of a peripheral interface, such as a USB, micro-USB interface, near-field magnetic coupling, magnetic inductive and magnetic resonance charging, and/or radio frequency (RF) charging), (iii) a power-management integrated circuit, configured to distribute power to various components of the device and to ensure that the device operates within safe limits (e.g., regulating voltage, controlling current flow, and/or managing heat dissipation), and/or (iv) a battery configured to store power to provide usable power to components of one or more electronic devices.

Peripheral interfaces may be electronic components (e.g., of electronic devices) that allow electronic devices to communicate with other devices or peripherals and can provide the ability to input and output data and signals. Examples of peripheral interfaces can include (i) universal serial bus (USB) and/or micro-USB interfaces configured for connecting devices to an electronic device, (ii) Bluetooth interfaces configured to allow devices to communicate with each other, including Bluetooth low energy (BLE), (iii) near field communication (NFC) interfaces configured to be short-range wireless interfaces for operations such as access control, (iv) POGO pins, which may be small, spring-loaded pins configured to provide a charging interface, (v) wireless charging interfaces, (vi) GPS interfaces, (vii) Wi-Fi interfaces for providing a connection between a device and a wireless network, and/or (viii) sensor interfaces.

Sensors may be electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device), (ii) biopotential-signal sensors, (iii) inertial measurement units (e.g., IMUs) for detecting, for example, angular rate, force, magnetic field, and/or changes in acceleration, (iv) heart rate sensors for measuring a user's heart rate, (v) SpO2 sensors for measuring blood oxygen saturation and/or other biometric data of a user, (vi) capacitive sensors for detecting changes in potential at a portion of a user's body (e.g., a sensor-skin interface), and/or (vii) light sensors (e.g., time-of-flight sensors, infrared light sensors, visible light sensors, etc.).

Biopotential-signal-sensing components may be devices used to measure electrical activity within the body (e.g., biopotential-signal sensors). Some types of biopotential-signal sensors include (i) electroencephalography (EEG) sensors configured to measure electrical activity in the brain to diagnose neurological disorders, (ii) electrocardiography (ECG or EKG) sensors configured to measure electrical activity of the heart to diagnose heart problems, (iii) electromyography (EMG) sensors configured to measure the electrical activity of muscles and to diagnose neuromuscular disorders, and (iv) electrooculography (EOG) sensors configure to measure the electrical activity of eye muscles to detect eye movement and diagnose eye disorders.

An application stored in memory of an electronic device (e.g., software) may include instructions stored in the memory. Examples of such applications include (i) games, (ii) word processors, (iii) messaging applications, (iv) media-streaming applications, (v) financial applications, (vi) calendars. (vii) clocks, and (viii) communication interface modules for enabling wired and/or wireless connections between different respective electronic devices (e.g., IEEE 1202.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocols).

A communication interface may be a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, Bluetooth). In some embodiments, a communication interface can refer to a software layer that enables different software programs to communicate with each other (e.g., application programming interfaces (APIs), protocols like HTTP and TCP/IP, etc.).

A graphics module may be a component or software module that is designed to handle graphical operations and/or processes and can include a hardware module and/or a software module.

Non-transitory computer-readable storage media may be physical devices or storage media that can be used to store electronic data in a non-transitory form (e.g., such that the data is stored permanently until it is intentionally deleted or modified).

FIGS. 10 and 11 illustrate an example wrist-wearable device 1000 and an example computer system 1100, in accordance with some embodiments. Wrist-wearable device 1000 is an instance of wearable device 802 described in FIG. 8 herein, such that the wearable device 802 should be understood to have the features of the wrist-wearable device 1000 and vice versa. FIG. 11 illustrates components of the wrist-wearable device 1000, which can be used individually or in combination, including combinations that include other electronic devices and/or electronic components.

FIG. 10 shows a wearable band 1010 and a watch body 1020 (or capsule) being coupled, as discussed below, to form wrist-wearable device 1000. Wrist-wearable device 1000 can perform various functions and/or operations associated with navigating through user interfaces and selectively opening applications as well as the functions and/or operations described above with reference to FIGS. 8-9.

As will be described in more detail below, operations executed by wrist-wearable device 1000 can include (i) presenting content to a user (e.g., displaying visual content via a display 1005), (ii) detecting (e.g., sensing) user input (e.g., sensing a touch on peripheral button 1023 and/or at a touch screen of the display 1005, a hand gesture detected by sensors (e.g., biopotential sensors)), (iii) sensing biometric data (e.g., neuromuscular signals, heart rate, temperature, sleep, etc.) via one or more sensors 1013, messaging (e.g., text, speech, video, etc.); image capture via one or more imaging devices or cameras 1025, wireless communications (e.g., cellular, near field, Wi-Fi, personal area network, etc.), location determination, financial transactions, providing haptic feedback, providing alarms, providing notifications, providing biometric authentication, providing health monitoring, providing sleep monitoring, etc.

The above-example functions can be executed independently in watch body 1020, independently in wearable band 1010, and/or via an electronic communication between watch body 1020 and wearable band 1010. In some embodiments, functions can be executed on wrist-wearable device 1000 while an AR environment is being presented (e.g., via one of AR systems 800 to 900). The wearable devices described herein can also be used with other types of AR environments.

Wearable band 1010 can be configured to be worn by a user such that an inner surface of a wearable structure 1011 of wearable band 1010 is in contact with the user's skin. In this example, when worn by a user, sensors 1013 may contact the user's skin. In some examples, one or more of sensors 1013 can sense biometric data such as a user's heart rate, a saturated oxygen level, temperature, sweat level, neuromuscular signals, or a combination thereof. One or more of sensors 1013 can also sense data about a user's environment including a user's motion, altitude, location, orientation, gait, acceleration, position, or a combination thereof. In some embodiment, one or more of sensors 1013 can be configured to track a position and/or motion of wearable band 1010. One or more of sensors 1013 can include any of the sensors defined above and/or discussed below with respect to FIG. 10.

One or more of sensors 1013 can be distributed on an inside and/or an outside surface of wearable band 1010. In some embodiments, one or more of sensors 1013 are uniformly spaced along wearable band 1010. Alternatively, in some embodiments, one or more of sensors 1013 are positioned at distinct points along wearable band 1010. As shown in FIG. 10, one or more of sensors 1013 can be the same or distinct. For example, in some embodiments, one or more of sensors 1013 can be shaped as a pill (e.g., sensor 1013a), an oval, a circle a square, an oblong (e.g., sensor 1013c) and/or any other shape that maintains contact with the user's skin (e.g., such that neuromuscular signal and/or other biometric data can be accurately measured at the user's skin). In some embodiments, one or more sensors of 1013 are aligned to form pairs of sensors (e.g., for sensing neuromuscular signals based on differential sensing within each respective sensor). For example, sensor 1013b may be aligned with an adjacent sensor to form sensor pair 1014a and sensor 1013d may be aligned with an adjacent sensor to form sensor pair 1014b. In some embodiments, wearable band 1010 does not have a sensor pair. Alternatively, in some embodiments, wearable band 1010 has a predetermined number of sensor pairs (one pair of sensors, three pairs of sensors, four pairs of sensors, six pairs of sensors, sixteen pairs of sensors, etc.).

Wearable band 1010 can include any suitable number of sensors 1013. In some embodiments, the number and arrangement of sensors 1013 depends on the particular application for which wearable band 1010 is used. For instance, wearable band 1010 can be configured as an armband, wristband, or chest-band that include a plurality of sensors 1013 with different number of sensors 1013, a variety of types of individual sensors with the plurality of sensors 1013, and different arrangements for each use case, such as medical use cases as compared to gaming or general day-to-day use cases.

In accordance with some embodiments, wearable band 1010 further includes an electrical ground electrode and a shielding electrode. The electrical ground and shielding electrodes, like the sensors 1013, can be distributed on the inside surface of the wearable band 1010 such that they contact a portion of the user's skin. For example, the electrical ground and shielding electrodes can be at an inside surface of a coupling mechanism 1016 or an inside surface of a wearable structure 1011. The electrical ground and shielding electrodes can be formed and/or use the same components as sensors 1013. In some embodiments, wearable band 1010 includes more than one electrical ground electrode and more than one shielding electrode.

Sensors 1013 can be formed as part of wearable structure 1011 of wearable band 1010. In some embodiments, sensors 1013 are flush or substantially flush with wearable structure 1011 such that they do not extend beyond the surface of wearable structure 1011. While flush with wearable structure 1011, sensors 1013 are still configured to contact the user's skin (e.g., via a skin-contacting surface). Alternatively, in some embodiments, sensors 1013 extend beyond wearable structure 1011 a predetermined distance (e.g., 0.1-2 mm) to make contact and depress into the user's skin. In some embodiment, sensors 1013 are coupled to an actuator (not shown) configured to adjust an extension height (e.g., a distance from the surface of wearable structure 1011) of sensors 1013 such that sensors 1013 make contact and depress into the user's skin. In some embodiments, the actuators adjust the extension height between 0.01 mm-1.2 mm. This may allow a the user to customize the positioning of sensors 1013 to improve the overall comfort of the wearable band 1010 when worn while still allowing sensors 1013 to contact the user's skin. In some embodiments, sensors 1013 are indistinguishable from wearable structure 1011 when worn by the user.

Wearable structure 1011 can be formed of an elastic material, elastomers, etc., configured to be stretched and fitted to be worn by the user. In some embodiments, wearable structure 1011 is a textile or woven fabric. As described above, sensors 1013 can be formed as part of a wearable structure 1011. For example, sensors 1013 can be molded into the wearable structure 1011, be integrated into a woven fabric (e.g., sensors 1013 can be sewn into the fabric and mimic the pliability of fabric and can and/or be constructed from a series woven strands of fabric).

Wearable structure 1011 can include flexible electronic connectors that interconnect sensors 1013, the electronic circuitry, and/or other electronic components (described below in reference to FIG. 11) that are enclosed in wearable band 1010. In some embodiments, the flexible electronic connectors are configured to interconnect sensors 1013, the electronic circuitry, and/or other electronic components of wearable band 1010 with respective sensors and/or other electronic components of another electronic device (e.g., watch body 1020). The flexible electronic connectors are configured to move with wearable structure 1011 such that the user adjustment to wearable structure 1011 (e.g., resizing, pulling, folding, etc.) does not stress or strain the electrical coupling of components of wearable band 1010.

As described above, wearable band 1010 is configured to be worn by a user. In particular, wearable band 1010 can be shaped or otherwise manipulated to be worn by a user. For example, wearable band 1010 can be shaped to have a substantially circular shape such that it can be configured to be worn on the user's lower arm or wrist. Alternatively, wearable band 1010 can be shaped to be worn on another body part of the user, such as the user's upper arm (e.g., around a bicep), forearm, chest, legs, etc. Wearable band 1010 can include a retaining mechanism 1012 (e.g., a buckle, a hook and loop fastener, etc.) for securing wearable band 1010 to the user's wrist or other body part. While wearable band 1010 is worn by the user, sensors 1013 sense data (referred to as sensor data) from the user's skin. In some examples, sensors 1013 of wearable band 1010 obtain (e.g., sense and record) neuromuscular signals.

The sensed data (e.g., sensed neuromuscular signals) can be used to detect and/or determine the user's intention to perform certain motor actions. In some examples, sensors 1013 may sense and record neuromuscular signals from the user as the user performs muscular activations (e.g., movements, gestures, etc.). The detected and/or determined motor actions (e.g., phalange (or digit) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on display 1005 of wrist-wearable device 1000 and/or can be transmitted to a device responsible for rendering an artificial-reality environment (e.g., a head-mounted display) to perform an action in an associated artificial-reality environment, such as to control the motion of a virtual device displayed to the user. The muscular activations performed by the user can include static gestures, such as placing the user's hand palm down on a table, dynamic gestures, such as grasping a physical or virtual object, and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by sensors 1013 can be used to provide a user with an enhanced interaction with a physical object (e.g., devices communicatively coupled with wearable band 1010) and/or a virtual object in an artificial-reality application generated by an artificial-reality system (e.g., user interface objects presented on the display 1005, or another computing device (e.g., a smartphone)).

In some embodiments, wearable band 1010 includes one or more haptic devices 1146 (e.g., a vibratory haptic actuator) that are configured to provide haptic feedback (e.g., a cutaneous and/or kinesthetic sensation, etc.) to the user's skin. Sensors 1013 and/or haptic devices 1146 (shown in FIG. 11) can be configured to operate in conjunction with multiple applications including, without limitation, health monitoring, social media, games, and artificial reality (e.g., the applications associated with artificial reality).

Wearable band 1010 can also include coupling mechanism 1016 for detachably coupling a capsule (e.g., a computing unit) or watch body 1020 (via a coupling surface of the watch body 1020) to wearable band 1010. For example, a cradle or a shape of coupling mechanism 1016 can correspond to shape of watch body 1020 of wrist-wearable device 1000. In particular, coupling mechanism 1016 can be configured to receive a coupling surface proximate to the bottom side of watch body 1020 (e.g., a side opposite to a front side of watch body 1020 where display 1005 is located), such that a user can push watch body 1020 downward into coupling mechanism 1016 to attach watch body 1020 to coupling mechanism 1016. In some embodiments, coupling mechanism 1016 can be configured to receive a top side of the watch body 1020 (e.g., a side proximate to the front side of watch body 1020 where display 1005 is located) that is pushed upward into the cradle, as opposed to being pushed downward into coupling mechanism 1016. In some embodiments, coupling mechanism 1016 is an integrated component of wearable band 1010 such that wearable band 1010 and coupling mechanism 1016 are a single unitary structure. In some embodiments, coupling mechanism 1016 is a type of frame or shell that allows watch body 1020 coupling surface to be retained within or on wearable band 1010 coupling mechanism 1016 (e.g., a cradle, a tracker band, a support base, a clasp, etc.).

Coupling mechanism 1016 can allow for watch body 1020 to be detachably coupled to the wearable band 1010 through a friction fit, magnetic coupling, a rotation-based connector, a shear-pin coupler, a retention spring, one or more magnets, a clip, a pin shaft, a hook and loop fastener, or a combination thereof. A user can perform any type of motion to couple the watch body 1020 to wearable band 1010 and to decouple the watch body 1020 from the wearable band 1010. For example, a user can twist, slide, turn, push, pull, or rotate watch body 1020 relative to wearable band 1010, or a combination thereof, to attach watch body 1020 to wearable band 1010 and to detach watch body 1020 from wearable band 1010. Alternatively, as discussed below, in some embodiments, the watch body 1020 can be decoupled from the wearable band 1010 by actuation of a release mechanism 1029.

Wearable band 1010 can be coupled with watch body 1020 to increase the functionality of wearable band 1010 (e.g., converting wearable band 1010 into wrist-wearable device 1000, adding an additional computing unit and/or battery to increase computational resources and/or a battery life of wearable band 1010, adding additional sensors to improve sensed data, etc.). As described above, wearable band 1010 and coupling mechanism 1016 are configured to operate independently (e.g., execute functions independently) from watch body 1020. For example, coupling mechanism 1016 can include one or more sensors 1013 that contact a user's skin when wearable band 1010 is worn by the user, with or without watch body 1020 and can provide sensor data for determining control commands.

A user can detach watch body 1020 from wearable band 1010 to reduce the encumbrance of wrist-wearable device 1000 to the user. For embodiments in which watch body 1020 is removable, watch body 1020 can be referred to as a removable structure, such that in these embodiments wrist-wearable device 1000 includes a wearable portion (e.g., wearable band 1010) and a removable structure (e.g., watch body 1020).

Turning to watch body 1020, in some examples watch body 1020 can have a substantially rectangular or circular shape. Watch body 1020 is configured to be worn by the user on their wrist or on another body part. More specifically, watch body 1020 is sized to be easily carried by the user, attached on a portion of the user's clothing, and/or coupled to wearable band 1010 (forming the wrist-wearable device 1000). As described above, watch body 1020 can have a shape corresponding to coupling mechanism 1016 of wearable band 1010. In some embodiments, watch body 1020 includes a single release mechanism 1029 or multiple release mechanisms (e.g., two release mechanisms 1029 positioned on opposing sides of watch body 1020, such as spring-loaded buttons) for decoupling watch body 1020 from wearable band 1010. Release mechanism 1029 can include, without limitation, a button, a knob, a plunger, a handle, a lever, a fastener, a clasp, a dial, a latch, or a combination thereof.

A user can actuate release mechanism 1029 by pushing, turning, lifting, depressing, shifting, or performing other actions on release mechanism 1029. Actuation of release mechanism 1029 can release (e.g., decouple) watch body 1020 from coupling mechanism 1016 of wearable band 1010, allowing the user to use watch body 1020 independently from wearable band 1010 and vice versa. For example, decoupling watch body 1020 from wearable band 1010 can allow a user to capture images using rear-facing camera 1025b. Although release mechanism 1029 is shown positioned at a corner of watch body 1020, release mechanism 1029 can be positioned anywhere on watch body 1020 that is convenient for the user to actuate. In addition, in some embodiments, wearable band 1010 can also include a respective release mechanism for decoupling watch body 1020 from coupling mechanism 1016. In some embodiments, release mechanism 1029 is optional and watch body 1020 can be decoupled from coupling mechanism 1016 as described above (e.g., via twisting, rotating, etc.).

Watch body 1020 can include one or more peripheral buttons 1023 and 1027 for performing various operations at watch body 1020. For example, peripheral buttons 1023 and 1027 can be used to turn on or wake (e.g., transition from a sleep state to an active state) display 1005, unlock watch body 1020, increase or decrease a volume, increase or decrease a brightness, interact with one or more applications, interact with one or more user interfaces, etc. Additionally or alternatively, in some embodiments, display 1005 operates as a touch screen and allows the user to provide one or more inputs for interacting with watch body 1020.

In some embodiments, watch body 1020 includes one or more sensors 1021. Sensors 1021 of watch body 1020 can be the same or distinct from sensors 1013 of wearable band 1010. Sensors 1021 of watch body 1020 can be distributed on an inside and/or an outside surface of watch body 1020. In some embodiments, sensors 1021 are configured to contact a user's skin when watch body 1020 is worn by the user. For example, sensors 1021 can be placed on the bottom side of watch body 1020 and coupling mechanism 1016 can be a cradle with an opening that allows the bottom side of watch body 1020 to directly contact the user's skin. Alternatively, in some embodiments, watch body 1020 does not include sensors that are configured to contact the user's skin (e.g., including sensors internal and/or external to the watch body 1020 that are configured to sense data of watch body 1020 and the surrounding environment). In some embodiments, sensors 1021 are configured to track a position and/or motion of watch body 1020.

Watch body 1020 and wearable band 1010 can share data using a wired communication method (e.g., a Universal Asynchronous Receiver/Transmitter (UART), a USB transceiver, etc.) and/or a wireless communication method (e.g., near field communication, Bluetooth, etc.). For example, watch body 1020 and wearable band 1010 can share data sensed by sensors 1013 and 1021, as well as application and device specific information (e.g., active and/or available applications, output devices (e.g., displays, speakers, etc.), input devices (e.g., touch screens, microphones, imaging sensors, etc.).

In some embodiments, watch body 1020 can include, without limitation, a front-facing camera 1025a and/or a rear-facing camera 1025b, sensors 1021 (e.g., a biometric sensor, an IMU, a heart rate sensor, a saturated oxygen sensor, a neuromuscular signal sensor, an altimeter sensor, a temperature sensor, a bioimpedance sensor, a pedometer sensor, an optical sensor (e.g., imaging sensor 1163), a touch sensor, a sweat sensor, etc.). In some embodiments, watch body 1020 can include one or more haptic devices 1176 (e.g., a vibratory haptic actuator) that is configured to provide haptic feedback (e.g., a cutaneous and/or kinesthetic sensation, etc.) to the user. Sensors 1121 and/or haptic device 1176 can also be configured to operate in conjunction with multiple applications including, without limitation, health monitoring applications, social media applications, game applications, and artificial reality applications (e.g., the applications associated with artificial reality).

As described above, watch body 1020 and wearable band 1010, when coupled, can form wrist-wearable device 1000. When coupled, watch body 1020 and wearable band 1010 may operate as a single device to execute functions (operations, detections, communications, etc.) described herein. In some embodiments, each device may be provided with particular instructions for performing the one or more operations of wrist-wearable device 1000. For example, in accordance with a determination that watch body 1020 does not include neuromuscular signal sensors, wearable band 1010 can include alternative instructions for performing associated instructions (e.g., providing sensed neuromuscular signal data to watch body 1020 via a different electronic device). Operations of wrist-wearable device 1000 can be performed by watch body 1020 alone or in conjunction with wearable band 1010 (e.g., via respective processors and/or hardware components) and vice versa. In some embodiments, operations of wrist-wearable device 1000, watch body 1020, and/or wearable band 1010 can be performed in conjunction with one or more processors and/or hardware components.

As described below with reference to the block diagram of FIG. 11, wearable band 1010 and/or watch body 1020 can each include independent resources required to independently execute functions. For example, wearable band 1010 and/or watch body 1020 can each include a power source (e.g., a battery), a memory, data storage, a processor (e.g., a central processing unit (CPU)), communications, a light source, and/or input/output devices.

FIG. 11 shows block diagrams of a computing system 1130 corresponding to wearable band 1010 and a computing system 1160 corresponding to watch body 1020 according to some embodiments. Computing system 1100 of wrist-wearable device 1000 may include a combination of components of wearable band computing system 1130 and watch body computing system 1160, in accordance with some embodiments.

Watch body 1020 and/or wearable band 1010 can include one or more components shown in watch body computing system 1160. In some embodiments, a single integrated circuit may include all or a substantial portion of the components of watch body computing system 1160 included in a single integrated circuit. Alternatively, in some embodiments, components of the watch body computing system 1160 may be included in a plurality of integrated circuits that are communicatively coupled. In some embodiments, watch body computing system 1160 may be configured to couple (e.g., via a wired or wireless connection) with wearable band computing system 1130, which may allow the computing systems to share components, distribute tasks, and/or perform other operations described herein (individually or as a single device).

Watch body computing system 1160 can include one or more processors 1179, a controller 1177, a peripherals interface 1161, a power system 1195, and memory (e.g., a memory 1180).

Power system 1195 can include a charger input 1196, a power-management integrated circuit (PMIC) 1197, and a battery 1198. In some embodiments, a watch body 1020 and a wearable band 1010 can have respective batteries (e.g., battery 1198 and 1159) and can share power with each other. Watch body 1020 and wearable band 1010 can receive a charge using a variety of techniques. In some embodiments, watch body 1020 and wearable band 1010 can use a wired charging assembly (e.g., power cords) to receive the charge. Alternatively, or in addition, watch body 1020 and/or wearable band 1010 can be configured for wireless charging. For example, a portable charging device can be designed to mate with a portion of watch body 1020 and/or wearable band 1010 and wirelessly deliver usable power to battery 1198 of watch body 1020 and/or battery 1159 of wearable band 1010. Watch body 1020 and wearable band 1010 can have independent power systems (e.g., power system 1195 and 1156, respectively) to enable each to operate independently. Watch body 1020 and wearable band 1010 can also share power (e.g., one can charge the other) via respective PMICs (e.g., PMICs 1197 and 1158) and charger inputs (e.g., 1157 and 1196) that can share power over power and ground conductors and/or over wireless charging antennas.

In some embodiments, peripherals interface 1161 can include one or more sensors 1121. Sensors 1121 can include one or more coupling sensors 1162 for detecting when watch body 1020 is coupled with another electronic device (e.g., a wearable band 1010). Sensors 1121 can include one or more imaging sensors 1163 (e.g., one or more of cameras 1125, and/or separate imaging sensors 1163 (e.g., thermal-imaging sensors)). In some embodiments, sensors 1121 can include one or more SpO2 sensors 1164. In some embodiments, sensors 1121 can include one or more biopotential-signal sensors (e.g., EMG sensors 1165, which may be disposed on an interior, user-facing portion of watch body 1020 and/or wearable band 1010). In some embodiments, sensors 1121 may include one or more capacitive sensors 1166. In some embodiments, sensors 1121 may include one or more heart rate sensors 1167. In some embodiments, sensors 1121 may include one or more IMU sensors 1168. In some embodiments, one or more IMU sensors 1168 can be configured to detect movement of a user's hand or other location where watch body 1020 is placed or held.

In some embodiments, one or more of sensors 1121 may provide an example human-machine interface. For example, a set of neuromuscular sensors, such as EMG sensors 1165, may be arranged circumferentially around wearable band 1010 with an interior surface of EMG sensors 1165 being configured to contact a user's skin. Any suitable number of neuromuscular sensors may be used (e.g., between 2 and 20 sensors). The number and arrangement of neuromuscular sensors may depend on the particular application for which the wearable device is used. For example, wearable band 1010 can be used to generate control information for controlling an augmented reality system, a robot, controlling a vehicle, scrolling through text, controlling a virtual avatar, or any other suitable control task.

In some embodiments, neuromuscular sensors may be coupled together using flexible electronics incorporated into the wireless device, and the output of one or more of the sensing components can be optionally processed using hardware signal processing circuitry (e.g., to perform amplification, filtering, and/or rectification). In other embodiments, at least some signal processing of the output of the sensing components can be performed in software such as processors 1179. Thus, signal processing of signals sampled by the sensors can be performed in hardware, software, or by any suitable combination of hardware and software, as aspects of the technology described herein are not limited in this respect.

Neuromuscular signals may be processed in a variety of ways. For example, the output of EMG sensors 1165 may be provided to an analog front end, which may be configured to perform analog processing (e.g., amplification, noise reduction, filtering, etc.) on the recorded signals. The processed analog signals may then be provided to an analog-to-digital converter, which may convert the analog signals to digital signals that can be processed by one or more computer processors. Furthermore, although this example is as discussed in the context of interfaces with EMG sensors, the embodiments described herein can also be implemented in wearable interfaces with other types of sensors including, but not limited to, mechanomyography (MMG) sensors, sonomyography (SMG) sensors, and electrical impedance tomography (EIT) sensors.

In some embodiments, peripherals interface 1161 includes a near-field communication (NFC) component 1169, a global-position system (GPS) component 1170, a long-term evolution (LTE) component 1171, and/or a Wi-Fi and/or Bluetooth communication component 1172. In some embodiments, peripherals interface 1161 includes one or more buttons 1173 (e.g., peripheral buttons 1023 and 1027 in FIG. 10), which, when selected by a user, cause operation to be performed at watch body 1020. In some embodiments, the peripherals interface 1161 includes one or more indicators, such as a light emitting diode (LED), to provide a user with visual indicators (e.g., message received, low battery, active microphone and/or camera, etc.).

Watch body 1020 can include at least one display 1005 for displaying visual representations of information or data to a user, including user-interface elements and/or three-dimensional virtual objects. The display can also include a touch screen for inputting user inputs, such as touch gestures, swipe gestures, and the like. Watch body 1020 can include at least one speaker 1174 and at least one microphone 1175 for providing audio signals to the user and receiving audio input from the user. The user can provide user inputs through microphone 1175 and can also receive audio output from speaker 1174 as part of a haptic event provided by haptic controller 1178. Watch body 1020 can include at least one camera 1125, including a front camera 1125a and a rear camera 1125b. Cameras 1125 can include ultra-wide-angle cameras, wide angle cameras, fish-eye cameras, spherical cameras, telephoto cameras, depth-sensing cameras, or other types of cameras.

Watch body computing system 1160 can include one or more haptic controllers 1178 and associated componentry (e.g., haptic devices 1176) for providing haptic events at watch body 1020 (e.g., a vibrating sensation or audio output in response to an event at the watch body 1020). Haptic controllers 1178 can communicate with one or more haptic devices 1176, such as electroacoustic devices, including a speaker of the one or more speakers 1174 and/or other audio components and/or electromechanical devices that convert energy into linear motion such as a motor, solenoid, electroactive polymer, piezoelectric actuator, electrostatic actuator, or other tactile output generating components (e.g., a component that converts electrical signals into tactile outputs on the device). Haptic controller 1178 can provide haptic events to that are capable of being sensed by a user of watch body 1020. In some embodiments, one or more haptic controllers 1178 can receive input signals from an application of applications 1182.

In some embodiments, wearable band computing system 1130 and/or watch body computing system 1160 can include memory 1180, which can be controlled by one or more memory controllers of controllers 1177. In some embodiments, software components stored in memory 1180 include one or more applications 1182 configured to perform operations at the watch body 1020. In some embodiments, one or more applications 1182 may include games, word processors, messaging applications, calling applications, web browsers, social media applications, media streaming applications, financial applications, calendars, clocks, etc. In some embodiments, software components stored in memory 1180 include one or more communication interface modules 1183 as defined above. In some embodiments, software components stored in memory 1180 include one or more graphics modules 1184 for rendering, encoding, and/or decoding audio and/or visual data and one or more data management modules 1185 for collecting, organizing, and/or providing access to data 1187 stored in memory 1180. In some embodiments, one or more of applications 1182 and/or one or more modules can work in conjunction with one another to perform various tasks at the watch body 1020.

In some embodiments, software components stored in memory 1180 can include one or more operating systems 1181 (e.g., a Linux-based operating system, an Android operating system, etc.). Memory 1180 can also include data 1187. Data 1187 can include profile data 1188A, sensor data 1189A, media content data 1190, and application data 1191.

It should be appreciated that watch body computing system 1160 is an example of a computing system within watch body 1020, and that watch body 1020 can have more or fewer components than shown in watch body computing system 1160, can combine two or more components, and/or can have a different configuration and/or arrangement of the components. The various components shown in watch body computing system 1160 are implemented in hardware, software, firmware, or a combination thereof, including one or more signal processing and/or application-specific integrated circuits.

Turning to the wearable band computing system 1130, one or more components that can be included in wearable band 1010 are shown. Wearable band computing system 1130 can include more or fewer components than shown in watch body computing system 1160, can combine two or more components, and/or can have a different configuration and/or arrangement of some or all of the components. In some embodiments, all, or a substantial portion of the components of wearable band computing system 1130 are included in a single integrated circuit. Alternatively, in some embodiments, components of wearable band computing system 1130 are included in a plurality of integrated circuits that are communicatively coupled. As described above, in some embodiments, wearable band computing system 1130 is configured to couple (e.g., via a wired or wireless connection) with watch body computing system 1160, which allows the computing systems to share components, distribute tasks, and/or perform other operations described herein (individually or as a single device).

Wearable band computing system 1130, similar to watch body computing system 1160, can include one or more processors 1149, one or more controllers 1147 (including one or more haptics controllers 1148), a peripherals interface 1131 that can includes one or more sensors 1113 and other peripheral devices, a power source (e.g., a power system 1156), and memory (e.g., a memory 1150) that includes an operating system (e.g., an operating system 1151), data (e.g., data 1154 including profile data 1188B, sensor data 1189B, etc.), and one or more modules (e.g., a communications interface module 1152, a data management module 1153, etc.).

One or more of sensors 1113 can be analogous to sensors 1121 of watch body computing system 1160. For example, sensors 1113 can include one or more coupling sensors 1132, one or more SpO2 sensors 1134, one or more EMG sensors 1135, one or more capacitive sensors 1136, one or more heart rate sensors 1137, and one or more IMU sensors 1138.

Peripherals interface 1131 can also include other components analogous to those included in peripherals interface 1161 of watch body computing system 1160, including an NFC component 1139, a GPS component 1140, an LTE component 1141, a Wi-Fi and/or Bluetooth communication component 1142, and/or one or more haptic devices 1146 as described above in reference to peripherals interface 1161. In some embodiments, peripherals interface 1131 includes one or more buttons 1143, a display 1133, a speaker 1144, a microphone 1145, and a camera 1155. In some embodiments, peripherals interface 1131 includes one or more indicators, such as an LED.

It should be appreciated that wearable band computing system 1130 is an example of a computing system within wearable band 1010, and that wearable band 1010 can have more or fewer components than shown in wearable band computing system 1130, combine two or more components, and/or have a different configuration and/or arrangement of the components. The various components shown in wearable band computing system 1130 can be implemented in one or more of a combination of hardware, software, or firmware, including one or more signal processing and/or application-specific integrated circuits.

Wrist-wearable device 1000 with respect to FIG. 10 is an example of wearable band 1010 and watch body 1020 coupled together, so wrist-wearable device 1000 will be understood to include the components shown and described for wearable band computing system 1130 and watch body computing system 1160. In some embodiments, wrist-wearable device 1000 has a split architecture (e.g., a split mechanical architecture, a split electrical architecture, etc.) between watch body 1020 and wearable band 1010. In other words, all of the components shown in wearable band computing system 1130 and watch body computing system 1160 can be housed or otherwise disposed in a combined wrist-wearable device 1000 or within individual components of watch body 1020, wearable band 1010, and/or portions thereof (e.g., a coupling mechanism 1016 of wearable band 1010).

The techniques described above can be used with any device for sensing neuromuscular signals but could also be used with other types of wearable devices for sensing neuromuscular signals (such as body-wearable or head-wearable devices that might have neuromuscular sensors closer to the brain or spinal column).

In some embodiments, wrist-wearable device 1000 can be used in conjunction with a head-wearable device (e.g., AR glasses 1200 and VR system 1310) and/or an HIPD, and wrist-wearable device 1000 can also be configured to be used to allow a user to control any aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable devices, attention will now be turned to example head-wearable devices, such AR glasses 1200 and VR headset 1310.

FIGS. 12 to 13 show example artificial-reality systems, which can be used as or in connection with wrist-wearable device 1000. In some embodiments, AR system 1200 includes an eyewear device 1202, as shown in FIG. 12. In some embodiments, VR system 1310 includes a head-mounted display (HMD) 1312, as shown in FIGS. 13A and 13B. In some embodiments, AR system 1200 and VR system 1310 can include one or more analogous components (e.g., components for presenting interactive artificial-reality environments, such as processors, memory, and/or presentation devices, including one or more displays and/or one or more waveguides). As described herein, a head-wearable device can include components of eyewear device 1202 and/or head-mounted display 1312. Some embodiments of head-wearable devices do not include any displays, including any of the displays described with respect to AR system 1200 and/or VR system 1310. While the example artificial-reality systems are respectively described herein as AR system 1200 and VR system 1310, either or both of the example AR systems described herein can be configured to present fully-immersive virtual-reality scenes presented in substantially all of a user's field of view or subtler augmented-reality scenes that are presented within a portion, less than all, of the user's field of view.

FIG. 12 show an example visual depiction of AR system 1200, including an eyewear device 1202 (which may also be described herein as augmented-reality glasses, and/or smart glasses). AR system 1200 can include additional electronic components that are not shown in FIG. 12, such as a wearable accessory device and/or an intermediary processing device, in electronic communication or otherwise configured to be used in conjunction with the eyewear device 1202. In some embodiments, the wearable accessory device and/or the intermediary processing device may be configured to couple with eyewear device 1202 via a coupling mechanism in electronic communication with a coupling sensor (not shown), where the coupling sensor can detect when an electronic device becomes physically or electronically coupled with eyewear device 1202. In some embodiments, eyewear device 1202 can be configured to couple to a housing (not shown), which may include one or more additional coupling mechanisms configured to couple with additional accessory devices. The components shown in FIG. 12 can be implemented in hardware, software, firmware, or a combination thereof, including one or more signal-processing components and/or application-specific integrated circuits (ASICs).

Eyewear device 1202 includes mechanical glasses components, including a frame 1204 configured to hold one or more lenses (e.g., one or both lenses 1206-1 and 1206-2). One of ordinary skill in the art will appreciate that eyewear device 1202 can include additional mechanical components, such as hinges configured to allow portions of frame 1204 of eyewear device 1202 to be folded and unfolded, a bridge configured to span the gap between lenses 1206-1 and 1206-2 and rest on the user's nose, nose pads configured to rest on the bridge of the nose and provide support for eyewear device 1202, earpieces configured to rest on the user's ears and provide additional support for eyewear device 1202, temple arms configured to extend from the hinges to the earpieces of eyewear device 1202, and the like. One of ordinary skill in the art will further appreciate that some examples of AR system 1200 can include none of the mechanical components described herein. For example, smart contact lenses configured to present artificial reality to users may not include any components of eyewear device 1202.

Eyewear device 1202 includes electronic components. Some example electronic components are illustrated in FIG. 12, including acoustic sensors 1225-1, 1225-2, 1225-3, 1225-4, 1225-5, and 1225-6, which can be distributed along a substantial portion of the frame 1204 of eyewear device 1202. Eyewear device 1202 also includes a left camera 1239A and a right camera 1239B, which are located on different sides of the frame 1204. Eyewear device 1202 also includes a processor 1248 (or any other suitable type or form of integrated circuit) that is embedded into a portion of the frame 1204.

FIGS. 13A and 13B show a VR system 1310 that includes a head-mounted display (HMD) 1312 (e.g., also referred to herein as an artificial-reality headset, a head-wearable device, a VR headset, etc.), in accordance with some embodiments. As noted, some artificial-reality systems (e.g., AR system 1200) may, instead of blending an artificial reality with actual reality, substantially replace one or more of a user's visual and/or other sensory perceptions of the real world with a virtual experience.

HMD 1312 includes a front body 1314 and a frame 1316 (e.g., a strap or band) shaped to fit around a user's head. In some embodiments, front body 1314 and/or frame 1316 include one or more electronic elements for facilitating presentation of and/or interactions with an AR and/or VR system (e.g., displays, IMUs, tracking emitter or detectors). In some embodiments, HMD 1312 includes output audio transducers (e.g., an audio transducer 1318), as shown in FIG. 13B. In some embodiments, one or more components, such as the output audio transducer(s) 1318 and frame 1316, can be configured to attach and detach (e.g., are detachably attachable) to HMD 1312 (e.g., a portion or all of frame 1316, and/or audio transducer 1318), as shown in FIG. 13B. In some embodiments, coupling a detachable component to HMD 1312 causes the detachable component to come into electronic communication with HMD 1312.

FIGS. 13A and 13B also show that VR system 1310 includes one or more cameras, such as left camera 1339A and right camera 1339B, which can be analogous to left and right cameras 1239A and 1239B on frame 1204 of eyewear device 1202. In some embodiments, VR system 1310 includes one or more additional cameras (e.g., cameras 1339C and 1339D), which can be configured to augment image data obtained by left and right cameras 1339A and 1339B by providing more information. For example, camera 1339C can be used to supply color information that is not discerned by cameras 1339A and 1339B. In some embodiments, one or more of cameras 1339A to 1339D can include an optional IR cut filter configured to remove IR light from being received at the respective camera sensors.

AR systems can include a variety of types of visual feedback mechanisms (e.g., presentation devices). For example, display devices in AR system 1200 and/or VR system 1310 can include one or more liquid-crystal displays (LCDs), light emitting diode (LED) displays, organic LED (OLED) displays, and/or any other suitable types of display screens. Artificial-reality systems can include a single display screen (e.g., configured to be seen by both eyes), and/or can provide separate display screens for each eye, which can allow for additional flexibility for varifocal adjustments and/or for correcting a refractive error associated with a user's vision. Some embodiments of AR systems also include optical subsystems having one or more lenses (e.g., conventional concave or convex lenses, Fresnel lenses, or adjustable liquid lenses) through which a user can view a display screen.

In some situations, pairing external devices, such as an intermediary processing device (e.g., HIPD 806, 906) with eyewear device 1202 (e.g., as part of AR system 1200) enables eyewear device 1202 to achieve a similar form factor of a pair of glasses while still providing sufficient battery and computation power for expanded capabilities. Some, or all, of the battery power, computational resources, and/or additional features of AR system 1200 can be provided by a paired device or shared between a paired device and eyewear device 1202, thus reducing the weight, heat profile, and form factor of eyewear device 1202 overall while allowing eyewear device 1202 to retain its desired functionality. For example, the wearable accessory device can allow components that would otherwise be included on eyewear device 1202 to be included in the wearable accessory device and/or intermediary processing device, thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computation capacity than might otherwise have been possible on eyewear device 1202 standing alone. Because weight carried in the wearable accessory device can be less invasive to a user than weight carried in the eyewear device 1202, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user's day-to-day activities.

AR systems can include various types of computer vision components and subsystems. For example, AR system 1200 and/or VR system 1310 can include one or more optical sensors such as two-dimensional (2D) or three-dimensional (3D) cameras, time-of-flight depth sensors, structured light transmitters and detectors, single-beam or sweeping laser rangefinders, 3D LiDAR sensors, and/or any other suitable type or form of optical sensor. An AR system can process data from one or more of these sensors to identify a location of a user and/or aspects of the use's real-world physical surroundings, including the locations of real-world objects within the real-world physical surroundings. In some embodiments, the methods described herein are used to map the real world, to provide a user with context about real-world surroundings, and/or to generate digital twins (e.g., interactable virtual objects), among a variety of other functions. For example, FIGS. 13A and 13B show VR system 1310 having cameras 1339A to 1339D, which can be used to provide depth information for creating a voxel field and a two-dimensional mesh to provide object information to the user to avoid collisions.

In some embodiments, AR system 1200 and/or VR system 1310 can include haptic (tactile) feedback systems, which may be incorporated into headwear, gloves, body suits, handheld controllers, environmental devices (e.g., chairs or floormats), and/or any other type of device or system, such as the wearable devices discussed herein. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback may be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices.

In some embodiments of an artificial reality system, such as AR system 1200 and/or VR system 1310, ambient light (e.g., a live feed of the surrounding environment that a user would normally see) can be passed through a display element of a respective head-wearable device presenting aspects of the AR system. In some embodiments, ambient light can be passed through a portion less that is less than all of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable device, and an amount of ambient light (e.g., 15-50% of the ambient light) can be passed through the user interface element such that the user can distinguish at least a portion of the physical environment over which the user interface element is being displayed.

What is claimed is:

1. A device comprising:
a head-mounted display;
a rear unit that is adjustable to fit a user; and
a transition unit housing at least one electronic subsystem, wherein:
the transition unit extends between the head-mounted display and the rear unit so as to cover a top portion of a user's head when worn by the user; and
the transition unit comprises a front unit portion and a rear portion that is rotatable with respect to the front unit portion.

2. The device of claim 1, wherein the head-mounted display further comprises a thermal management system configured to cool the electronic subsystems passively.

3. The device of claim 1, wherein the head-mounted display comprises a friction-type hinge joint enabling dynamic rotation of the head-mounted display relative to the transition unit.

4. The device of claim 1, wherein the rear unit includes a fit adjustment mechanism that allows the rear unit to be variably adjusted.

5. The device of claim 1, wherein the rear unit comprises an audio subsystem configured to project sound to the user through a rear pad.

6. The device of claim 1, wherein the transition unit comprises a compound hinge configured to enable the rear portion and front portion to nest into each other when folded.

7. The device of claim 1, wherein the transition unit further comprises a sliding front module that is operable via a dial positioned on a surface of the head-mounted display, allowing the sliding front module to slide in and out relative to the head-mounted display.

8. The device of claim 1, wherein the transition unit further comprises a forced airflow system including an intake region configured to direct cool air into the device.

9. The device of claim 8, wherein the airflow system further comprises an exhaust region positioned above the user's head to expel hot air.

10. The device of claim 1, wherein the transition unit houses at least one antenna positioned along a z-axis of the transition unit.

11. A device comprising:
a head-mounted display; and
a rear unit that is adjustable and linked to the head-mounted display to fit a user, the rear unit housing at least one electronic subsystem, wherein:
the rear unit extends from the head-mounted display towards a back side of the user so as to cover a top portion of a user's head when worn by the user; and
the rear unit comprises a body that is be rotatable with respect to the head-mounted display.

12. The device of claim 11, wherein the rear unit further comprises an audio subsystem configured to transmit sound to the user through vibrations transmitted by a rear pad.

13. The device of claim 11, wherein the rear unit further comprises an exhaust fan for actively cooling the electronic subsystems housed in the rear unit.

14. The device of claim 11, wherein the rear unit further comprises a compound hinge joint that allows the rear unit to rotate dynamically with respect to the head-mounted display.

15. The device of claim 11, wherein the rear unit includes a fit adjustment mechanism that allows the rear unit to be variably adjusted to fit the user.

16. The device of claim 11, wherein the rear unit comprises electronic subsystems variably positioned along a y-axis and/or a z-axis of the rear unit to balance the device when worn by the user.

17. A method for a rotatable device comprising:
adjusting a device to fit a user's head by extending a rear unit of the device from a head-mounted display of the device towards a back portion of the user's head; and
rotating the rear unit with respect to the head-mounted display to optimize the fit on the user's head.

18. The method of claim 17, further comprising rotating a transition unit of the device that extends between the head-mounted display and the rear unit such that a rear portion of the transition unit rotates with respect to a front portion of the transition unit to collapse the device into a more compact form.

19. The method of claim 17, wherein the step of rotating the rear unit with respect to the head-mounted display includes using a compound hinge joint to enable the rotation.

20. The method of claim 17, wherein the step of adjusting the rear unit includes sliding the rear unit relative to the head-mounted display to variably adjust a fit for different users.
